(19) United States
(12) Patent Application Publication
(10) Pub. No.: US 2022/0388402 A1
(43) Pub. Date: Dec. 8, 2022

(54) AUTOMOBILE BRAKE CONTROL METHOD AND DEVICE, AND AUTOMOBILE

(71) Applicant: GUANGZHOU AUTOMOBILE GROUP CO., LTD., Guangzhou (CN)

(72) Inventors: Chengbin Zhou, Guangzhou (CN); Qinbo Xue, Guangzhou (CN); Lang LIU, Guangzhou (CN); Yang Cui, Guangzhou (CN); Jiandong Gu, Guangzhou (CN)

(21) Appl. No.: 17/776,714

(22) PCT Filed: Jun. 12, 2021
(86) PCT No.: PCT/CN2021/099902

§ 371 Date: May 13, 2022

(30) Foreign Application Priority Data
Jul. 21, 2020 (CN) 202010707887.3

(51) Int. Cl. B60L 7/18; B60T 17/22; B60T 8/92

(52) U.S. Cl. CPC B60L 7/18; B60T 17/22; B60T 8/92; B60T 2270/406; B60T 2270/403; B60L 7/22

(57) ABSTRACT

An automobile brake control method, a device, and an automobile. The method includes performing a real time monitoring for failure on an automobile brake system in real time; obtaining automobile working condition information when the automobile brake system is in a failure state; generating a failure determination result according to the automobile working condition information in the failure state; generating a reverse-dragging brake instruction corresponding to reverse-dragging brake condition and sending it to a motor controller, enabling the motor controller to perform the reverse-dragging brake according to the reverse-dragging brake instruction when determining the automobile working condition information after the failure of the brake system satisfies the reverse-dragging brake condition corresponding to the failure determination result. The method can control the motor to perform reverse-dragging brake when the brake system fails or the performance is reduced to a certain extent, so as to effectively improve the safety of the automobile.

### TECHNICAL FIELD

The present disclosure relates to the technical field of automobiles, in particular to an automobile brake control method and device, and automobile.

### BACKGROUND

At present, most automobiles generate electricity through the motor during reverse-dragging brake, thereby charging the battery to increase the cruising range. When the braking system fails, the automobile does not automatically perform reverse-dragging braking. Braking system failures generally include vacuum booster failure, electronically controlled booster failure, or pipeline system failure. When the vacuum booster fails or the electronically controlled booster fails, the brake must be applied manually, by stepping on the brake pedal. Manual braking pushes the brake master cylinder to establish hydraulic pressure, and the hydraulic pressure pushes out the wheel cylinder piston to clamp the brake disc to realize braking. Pipeline failures include single pipeline failure and/or dual pipeline failure at the same time. If both pipelines fail at the same time, braking the automobile will fail. When the above braking components or systems fail, the vehicle's normal braking distance will greatly increase, or even completely lose the braking ability, resulting in lower vehicle safety.

### SUMMARY OF THE DISCLOSURE

The embodiment of the present disclosure aims to provide a method for controlling the braking of an automobile and device to solve the above technical problems, so as to control the motor to perform reverse-dragging brake when the brake system fails or the braking performance is reduced to a certain extent, so as to effectively improve the safety of the automobile.

In order to solve the above technical problems, the embodiment of the present disclosure provides an automobile brake control method, includes:

performing a real time monitoring for failure on an automobile brake system;

obtaining automobile working condition information when the automobile brake system is in a failure state;

generating a corresponding failure determination result according to the automobile working condition information in the failure state; and

generating a reverse-dragging brake instruction corresponding to reverse-dragging brake condition and sending the reverse-dragging brake instruction to a motor controller, and enabling the motor controller to perform the reverse-dragging brake according to the reverse-dragging brake instruction when the automobile working condition information after the failure of the braking system is determined to satisfy the reverse-dragging brake condition corresponding to the failure determination result.

Further, the failure determination result comprises at least a first failure determination result, a second failure determination result, and a third failure determination result; wherein generating a corresponding failure determination result according to the automobile working condition information in the failure state includes:

generating the first failure determination result when degree of vacuum of a vacuum booster system is determined to be lower than a preset vacuum threshold and that an electronic stability system is determined to be failed according to the automobile working condition information in the failure state;

generating the second failure determination result when an electric control booster is determined to be completely failed and that the electronic stability system is determined to be failed according to the automobile working condition information in the failure state; and

generating the third failure determination result when brake pedal stroke is determined to be greater than a preset threshold, and that brake pipeline hydraulic pressure is determined to be lower than a preset hydraulic threshold, or that an automobile deceleration is determined to be lower than a preset deceleration threshold according to the automobile working condition information in the failure state.

Further, the automobile working condition information after the failure of the brake system is determined to satisfy the reverse-dragging brake condition corresponding to the failure determination result by:

determining that the preset first reverse-dragging brake condition is satisfied when the failure determination result is the first failure determination result, and that an automobile speed is greater than a preset first automobile speed threshold;

determining that the preset second reverse-dragging brake condition is satisfied when the failure determination result is the second failure determination result, and the automobile speed is greater than a preset second automobile speed threshold; and

determining that the preset third reverse-dragging brake condition is satisfied when the failure determination result is the third failure determination result, and the automobile speed is greater than a preset third automobile speed threshold.

Further, the reverse-dragging brake instruction corresponding to reverse-dragging brake condition is generated by:

querying corresponding brake strategy table according to the reverse-dragging brake condition satisfied by the automobile working condition information, obtaining a reverse-dragging torque corresponding to the brake pedal stroke, generating the reverse-dragging brake instruction according to obtained reverse-dragging torque and sending the reverse-dragging brake instruction to the motor controller.

Further, a method of constructing the brake strategy table includes:

the self-learning of a brake pedal in vacuum, obtaining a relationship between the brake pedal stroke and the reverse-dragging torque or quantity according to a required reverse-dragging deceleration; constructing the brake strategy table according to a relationship obtained, wherein the required reverse-dragging deceleration is the difference between a deceleration by manual braking and a preset target deceleration.

Further, the motor controller is enabled to perform the reverse-dragging brake according to the reverse-dragging brake instruction by:

enabling the motor controller to perform the reverse-dragging brake in combination with the reverse-dragging brake instruction, automobile battery state, and high voltage accessory state.

Further, the automobile brake control method further includes:

controlling the motor controller not to respond to the reverse-dragging brake instruction when a pedal stroke sensor failure and a brake switch sensor failure are detected.

In order to solve the same technical problem, the invention also provides an automobile braking control device, the device including a controller for:

performing a real time monitoring for failure on an automobile brake system;

obtaining automobile working condition information when the automobile brake system is in a failure state;

generating a corresponding failure determination result according to the automobile working condition information in the failure state; and

generating a reverse-dragging brake instruction corresponding to reverse-dragging brake condition and sending the reverse-dragging brake instruction to a motor controller, and enabling the motor controller to perform the reverse-dragging brake according to the reverse-dragging brake instruction when the automobile working condition information after the failure of the brake system is determined to satisfy the reverse-dragging brake condition corresponding to the failure determination result.

The present disclosure also provides an automobile, including the above brake control device.

Compared with the prior art, the present disclosure has the following beneficial effects:

The present disclosure provides an automobile brake control method and device. The method includes performing monitoring for failure on an automobile brake system in real time; obtaining automobile working condition information when the automobile brake system is in a failure state; generating a failure determination result according to the automobile working condition information in the failure state; generating a reverse-dragging brake instruction corresponding to reverse-dragging brake condition and sending it to a motor controller, enabling the motor controller to perform the reverse-dragging brake according to the reverse-dragging brake instruction when determining that the automobile working condition information after the failure of the brake system satisfies the reverse-dragging brake condition corresponding to the failure determination result. The present disclosure can control the motor to perform reverse-dragging brake when the brake system fails or when the performance is reduced to a certain extent, so as to effectively improve the safety of the automobile.

### BRIEF DESCRIPTION OF THE DRAWINGS

FIG. 1 is a flowchart of a method of controlling braking in an automobile according to an embodiment of the present disclosure.

FIG. 2 is a flowchart of another method of controlling braking in an automobile according to an embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work fall within the protection scope of the present disclosure.

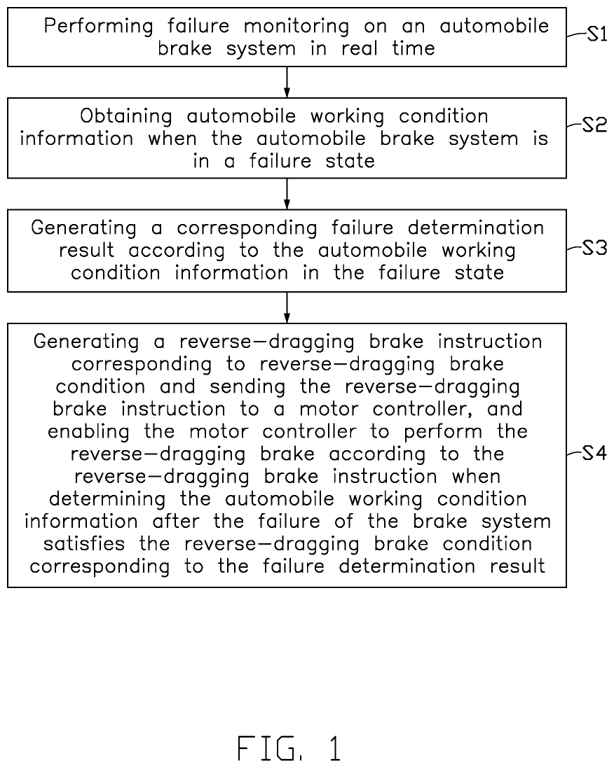

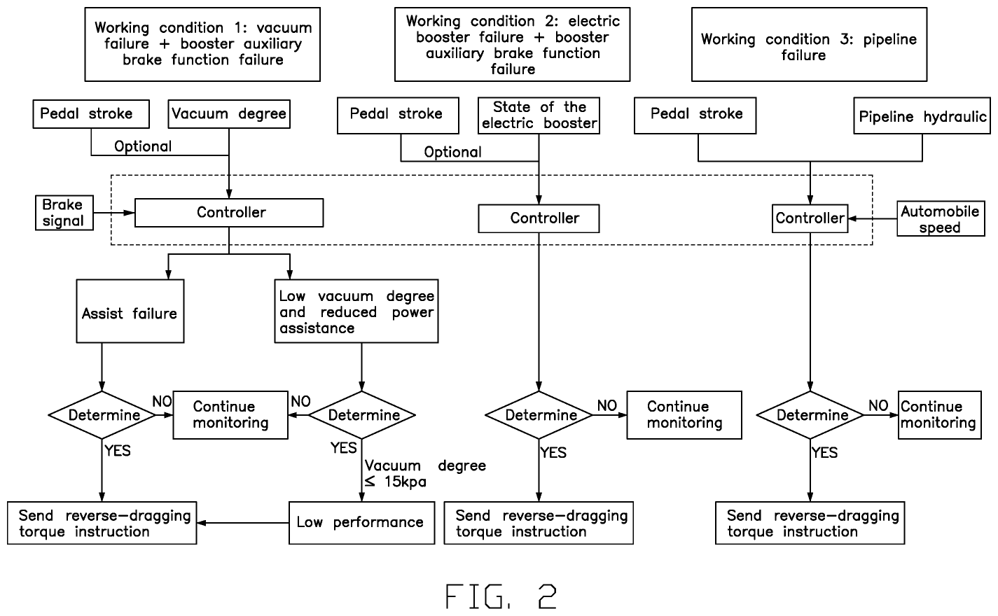

FIG. 1 and FIG. 2 illustrate an automobile brake control method in accordance with an embodiment of the present disclosure. The automobile brake control method includes the following steps:

At step S1, performing a real time monitoring for failure on an automobile brake system.

It should be noted that step S1 is to perform real time monitoring for failure on the automobile brake system and detect the working state of the components of the brake system through sensors, such as sensing the degree of the vacuum in the vacuum booster, the monitoring of the working state of the electronically controlled booster being equipped with the electronically controlled booster, the presence or level of hydraulic oil in the pipeline, etc. For automobiles already equipped with detection sensors (such as vacuum sensors, pedal displacement sensors, etc.), the cost and weight of components will not be increased, but the safety of the automobile will be greatly improved.

At step S2, obtaining automobile working condition information when the automobile brake system is in a failure state.

Step S2 is to obtain the current automobile working condition information when the failure of the automobile brake system is detected, including but not limited to obtaining a working state of the brake system, brake pedal travel information, speed of automobile etc. The information so obtained is used for subsequent determination of automobile failure conditions and determination of reverse-dragging brake condition.

At step S3, generating a failure determination result according to the automobile working condition information being in the failure state.

In the embodiment of the present disclosure, further, the failure determination result can include at least a first failure determination result, a second failure determination result, and a third failure determination result, step S3 being:

Generating the first failure determination result when determining that the vacuum degree of the vacuum booster system is lower than the preset vacuum threshold and that the electronic stability system is failed according to the automobile working condition information in the failure state.

Generating the second failure determination result when determining that the electric control booster is completely failed and that the electronic stability system is failed according to the automobile working condition information in the failure state.

Generating the third failure determination result when determining that the brake pedal stroke is greater than the preset threshold, and that the brake pipeline hydraulic pressure is lower than the preset hydraulic threshold or that the automobile deceleration is lower than the preset deceleration threshold according to the automobile working condition information in the failure state.

It should be noted that step S3 is to determine the automobile failure and determine the corresponding reverse-dragging brake condition according to several different types of failure.

At step S4, generating a reverse-dragging brake instruction corresponding to the reverse-dragging brake condition and sending the reverse-dragging brake instruction to the motor controller and enabling the motor controller to perform the reverse-dragging brake according to the reverse-dragging brake instruction when determining that the automobile working condition information after the failure of the brake system satisfies the reverse-dragging brake condition corresponding to the failure determination result.

In the embodiment of the present disclosure, further, determining that the automobile working condition information after the failure of the brake system does satisfy the reverse-dragging brake condition corresponding to the failure determination result, specifically includes:

Determining that the preset first reverse-dragging brake condition is satisfied when the failure determination result is the first failure determination result, and also determining, if it be the case, that the automobile speed is greater than the preset first automobile speed threshold includes;

Determining that preset second reverse-dragging brake condition is satisfied when the failure determination result is the second failure determination result, and it is determined that the automobile speed is greater than the preset second automobile speed threshold;

Determining that preset third reverse-dragging brake condition is satisfied when the failure determination result is the third failure determination result, and it is determined that the automobile speed is greater than the preset third automobile speed threshold.

In the embodiment of the present disclosure, further, the generating of a reverse-dragging brake instruction corresponding to the reverse-dragging brake condition and sending the reverse-dragging brake instruction to the motor controller specifically includes:

Querying the corresponding brake strategy table when the reverse-dragging brake condition is satisfied by the automobile working condition information, obtaining the reverse-dragging torque or force corresponding to the brake pedal stroke, and generating the reverse-dragging brake instruction according to the obtained reverse-dragging torque and sending the reverse-dragging brake instruction to the motor controller.

In the embodiment of the present disclosure, further, the method of constructing the brake strategy table is:

Self-learning of the brake pedal in vacuum, obtaining the relationship between the brake pedal stroke and the reverse-dragging torque or force according to the required reverse-dragging deceleration; constructing the brake strategy table according to the such obtained relationship; wherein the required reverse-dragging deceleration is the difference between the brake system deceleration and the preset target deceleration.

It should be noted that the preset target deceleration is equal to the deceleration by driver braking, the driver operating the brake on the basis of the superimposed motor reverse-dragging deceleration, for example, a deceleration of 4 m/s² can be calibrated.

The rate of the motor reverse-dragging deceleration can be related to the pedal stroke. Through the self-learning of the pedal stroke in the vacuum failure state, different reverse-dragging decelerations (reverse-dragging torque or force) are required to calibrate different pedal strokes.

In the embodiment of the present disclosure, further, the enabling of the motor controller to perform the reverse-dragging braking according to the reverse-dragging brake instruction, specifically includes:

enabling the motor controller to perform the reverse-dragging brake in combination with the reverse-dragging brake instruction, and information as to the state of the automobile battery and states of high voltage accessories.

After the motor controller receives the reverse-dragging brake instruction, a comprehensive determination is made according to the state of the battery and the states of high voltage accessories and the reverse-dragging brake is executed to decelerate the automobile. If the expected deceleration cannot be achieved because of the battery being fully charged, the high voltage components can be switched on to consume electrical charge from the battery or directly from the motor.

In the embodiment of the present disclosure, further, the automobile brake control method further includes:

Controlling the motor controller not to respond to the reverse-dragging brake instruction when a pedal stroke sensor failure and a brake switch sensor failure are detected.

It should be noted that the reverse-dragging brake function is activated when the driver has a brake request (the brake pedal is depressed and the brake switch sensor is activated). However, if a malfunction of the pedal travel sensor and the brake switch sensor is detected, the reverse-dragging brake function is not activated.

Based on the above solutions, the following specific reverse-dragging brake solutions are listed:

Working condition 1: the vacuum booster is failed or the performance is degraded, and the electronic stability system (ESC) is failed at the same time;

Specifically, when it is detected that the degree of vacuum is zero or lower than a certain threshold value (such as 15 KPa, which can be calibrated), and the electronic stability system fails (the boost auxiliary brake function fails);

If it is determined that the speed of the automobile is greater than 5 km/h (higher than crawling speed, which can be calibrated) according to the automobile working condition information, it is determined that the reverse-dragging brake condition is satisfied, at this time, according to the preset brake strategy table (as shown in Table 1). The reverse-dragging torque corresponding to the brake pedal stroke is obtained, the reverse-dragging brake instruction is issued according to the obtained reverse-dragging torque and the reverse-dragging brake instruction is sent to the motor controller, the motor controller makes a comprehensive determination according to the battery state and the high voltage accessory state, and performs reverse-dragging brake to decelerate the automobile.

TABLE 1

| pedal stroke (mm) or pedal depth (%) | reverse-dragging torque (n · m) |
|---|---|
| 0 | 0 |
| 5 | 0 |
| 10 | 0 |
| 15 | 0 |
| 20 | 200 |
| 25 | 400 |
| 30 | maximum |
| . . . | maximum |

Working condition 2: the electronic booster is completely failed and the electronic stability system (ESC) is failed at the same time;

Specifically, when it is detected that the electronic booster is completely failed, the electronic booster sends a failure signal, and the electronic stability system fails (the boost auxiliary braking function is failed);

If it is determined that the speed of the automobile is greater than 5 km/h (higher than crawling speed, which can be calibrated) according to the automobile working condition information, it is determined that the reverse-dragging brake condition is satisfied, at this time, according to the preset brake strategy table (as shown in Table 1). The reverse-dragging torque corresponding to the brake pedal stroke is obtained, generate the reverse-dragging brake instruction according to the obtained reverse-dragging torque and send the reverse-dragging brake instruction to the motor controller, the motor controller makes a comprehensive determination according to the battery state and the high voltage accessory state, and performs reverse-dragging brake to decelerate the automobile.

Working condition 3.1: pipeline failure (single pipeline).

The brake pedal stroke sensor monitors the pedal being depressed to a stroke greater than 50 mm (which can be calibrated). If the hydraulic sensor in the pipeline detects that the pipeline hydraulic pressure is lower than a normal working value to a certain threshold value (generally <1 MPa, which can be calibrated), or the deceleration sensor detects that the deceleration is lower than a certain threshold value (generally <1 m/s², which can be calibrated), and the automobile speed is more than 5 km/h (higher than the crawling speed, which can be calibrated), it is determined that the reverse-dragging brake condition is satisfied. At this time, according to the preset brake strategy table (as shown in Table 2), the reverse-dragging torque corresponding to the brake pedal stroke is obtained, generate the reverse-dragging brake instruction according to the obtained reverse-dragging torque and send the reverse-dragging brake instruction to the motor controller (or the VCU automobile controller). The motor controller (or the VCU automobile controller) makes a comprehensive determination according to the battery state and the high voltage accessory state, and performs reverse-dragging brake to decelerate the automobile.

TABLE 2

| pedal stroke (mm) or pedal depth (%) | reverse-dragging torque (n · m) |
|---|---|
| 0 | 0 |
| 20 | 0 |
| 40 | 0 |
| 60 | 200 |
| 70 | 400 |
| 80 | 600 |
| 90 | maximum |
| . . . | maximum |

Working condition 3.1: pipeline failure (double pipeline).

The brake pedal stroke sensor monitors that the pedal is depressed to a stroke greater than 70 mm (which can be calibrated). If the hydraulic sensor in the pipeline detects that the pipeline hydraulic pressure is lower than a normal working value to a certain threshold value (generally <1 MPa, which can be calibrated), or the deceleration sensor detects that the deceleration is lower than a certain threshold value (generally <1 m/s², which can be calibrated), and the automobile speed is more than 5 km/h (higher than the crawling speed, which can be calibrated), it is determined that the reverse-dragging brake condition is satisfied, at this time, according to the preset brake strategy table (as shown in Table 3), the reverse-dragging torque corresponding to the brake pedal stroke is obtained, generate the reverse-dragging brake instruction according to the obtained reverse-dragging torque and send the reverse-dragging brake instruction to the motor controller (or the VCU automobile controller). The motor controller (or the VCU automobile controller) makes a comprehensive determination according to the battery state and the high voltage accessory state and performs reverse-dragging brake to decelerate the automobile.

TABLE 3

| pedal stroke (mm) or pedal depth (%) | reverse-dragging torque (n · m) |
|---|---|
| 0 | 0 |
| 20 | 0 |
| 60 | 0 |
| 70 | 0 |
| 80 | 200 |
| 90 | 500 |
| 100 | maximum |
| . . . | maximum |

Compared with the prior art, the present disclosure has the following beneficial effects:

The present disclosure detects the working state of all parts of the brake system through the sensor, when it is detected that the brake parts or system fails or the performance is reduced to a certain extent, the present disclosure sends the reverse-dragging brake instruction to the motor controller to control the motor to perform the reverse-dragging brake, realize the deceleration of the automobile, ensure that the automobile can still produce a certain deceleration when part or the entire brake system fails, reduce the braking distance of the automobile and improve the safety of the automobile.

It should be noted that the above method or process embodiments are expressed as a series of action combinations for simple description. However, those skilled in the art should know that the embodiment of the present disclosure is not limited by the action sequence described, because according to the embodiment of the present disclosure, some steps can be carried out in other sequences or at the same time. Secondly, those skilled in the art should also know that the embodiments described in the specification are optional embodiments, and the actions involved are not necessarily required for the embodiments of the present disclosure.

In order to solve the same technical problem, the present disclosure also provides an automobile brake control device, the automobile brake control device includes a controller, and the controller is used for:

Performing a real time monitoring for failure on an automobile brake system;

Obtaining automobile working condition information when the automobile brake system is in a failure state;

Generating a failure determination result according to the automobile working condition information in the failure state; and

Generating a reverse-dragging brake instruction corresponding to the reverse-dragging brake condition and sending the reverse-dragging brake instruction to the motor controller and enabling the motor controller to perform the reverse-dragging brake according to the reverse-dragging brake instruction when determining that the automobile working condition information after the failure of the brake system satisfies the reverse-dragging brake condition corresponding to the failure determination result.

The present disclosure also provides an automobile, the automobile includes the automobile brake control device.

It can be understood that the above device embodiments correspond to the method embodiments of the present disclosure, the automobile brake control device provided by the embodiments of the present disclosure can realize the automobile brake control method provided by any method embodiment of the present disclosure.

The above is the preferred embodiment of the present disclosure, it should be pointed out that ordinary technicians in the technical field can also make several improvements and refinements without departing from the principles of the present disclosure, which are also regarded as the protection scope of the present disclosure.

What is claimed is:

1. An automobile brake control method comprising:
performing a real time monitoring of failures on an automobile brake system;
obtaining automobile working condition information when the automobile brake system is in a failure state;
generating a corresponding failure determination result according to the automobile working condition information in the failure state; and
generating a reverse-dragging brake instruction corresponding to reverse-dragging brake condition and sending the reverse-dragging brake instruction to a motor controller, and enabling the motor controller to perform the reverse-dragging brake according to the reverse-dragging brake instruction when the automobile working condition information after the failure of the brake system is determined to satisfy the reverse-dragging brake condition corresponding to the failure determination result.

2. The automobile brake control method of claim 1, wherein the failure determination result comprises at least a first failure determination result, a second failure determination result and a third failure determination result; wherein generating a corresponding failure determination result according to the automobile working condition information in the failure state comprises:
generating the first failure determination result when vacuum degree of a vacuum booster system is determined to be lower than a preset vacuum threshold and an electronic stability system is determined to be failed according to the automobile working condition information in the failure state;
generating the second failure determination result when an electric control booster is determined to be completely failed and the electronic stability system is determined to be failed according to the automobile working condition information in the failure state; and
generating the third failure determination result when brake pedal stroke is determined to be greater than a preset threshold, and brake pipeline hydraulic pressure is determined to be lower than a preset hydraulic threshold or an automobile deceleration is determined to be lower than a preset deceleration threshold according to the automobile working condition information in the failure state.

3. The automobile brake control method of claim 2, wherein the automobile working condition information after the failure of the brake system is determined to satisfy the reverse-dragging brake condition corresponding to the failure determination result by:
determining preset first reverse-dragging brake condition is satisfied when the failure determination result is the first failure determination result, and an automobile speed is greater than a preset first automobile speed threshold;
determining preset second reverse-dragging brake condition is satisfied when the failure determination result is the second failure determination result, and the automobile speed is greater than a preset second automobile speed threshold; and
determining preset third reverse-dragging brake condition is satisfied when the failure determination result is the third failure determination result, and the automobile speed is greater than a preset third automobile speed threshold.

4. The automobile brake control method of claim 3, wherein the reverse-dragging brake instruction corresponding to reverse-dragging brake condition is generated by:
querying corresponding brake strategy table according to the reverse-dragging brake condition satisfied by the automobile working condition information, obtaining a reverse-dragging torque corresponding to the brake pedal stroke, generating the reverse-dragging brake instruction according to obtained reverse-dragging torque and sending the reverse-dragging brake instruction to the motor controller.

5. The automobile brake control method of claim 4, wherein a method of constructing the brake strategy table comprises:
self-learning of a brake pedal in vacuum, obtaining a corresponding relationship between the brake pedal stroke and the reverse-dragging torque according to a required reverse-dragging deceleration; constructing the brake strategy table according to an obtained corresponding relationship; wherein the required reverse-dragging deceleration is the difference between a brake system deceleration and a preset target deceleration.

6. The automobile brake control method of claim 1, wherein the motor controller is enabled to perform the reverse-dragging brake according to the reverse-dragging brake instruction by:
enabling the motor controller to perform the reverse-dragging brake in combination with the reverse-dragging brake instruction, automobile battery state, and high voltage accessory state.

7. The automobile brake control method of claim 1, further comprising:
controlling the motor controller not to respond to the reverse-dragging brake instruction when a pedal stroke sensor failure and a brake switch sensor failure are detected.

8. An automobile brake control device comprising:
a controller configured for:
performing a real time monitoring for failure on an automobile brake system;
obtaining automobile working condition information when the automobile brake system is in a failure state;
generating a corresponding failure determination result according to the automobile working condition information in the failure state; and
generating a reverse-dragging brake instruction corresponding to reverse-dragging brake condition and sending the reverse-dragging brake instruction to a motor controller, and enabling the motor controller to perform the reverse-dragging brake according to the reverse-dragging brake instruction when the automobile working condition information after the failure of the brake system is determined to satisfy the reverse-dragging brake condition corresponding to the failure determination result.

9. An automobile, which comprises an automobile brake control device as claimed in claim 8.
